(19) United States
(12) Patent Application Publication
(10) Pub. No.: US 2007/0073476 A1
(43) Pub. Date: Mar. 29, 2007

(54) Apparatus and method for searching for place name according to individual moving pattern

(75) Inventors: Hee-seob Ryu, Suwon-si (KR); Soo-hyun Bae, Seoul (KR); Jong-ho Lea, Seongnam-si (KR); Soon-joo Kwon, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/507,561

(22) Filed: Aug. 22, 2006

(30) Foreign Application Priority Data
Sep. 28, 2005 (KR) 10-2005-0090588

(51) Int. Cl. G01C 21/00

(52) U.S. Cl. 701/208; 701/201

(57) ABSTRACT

An apparatus and method for searching for a place name according to an individual moving pattern is disclosed, whereby a user can search for a place name corresponding to a place where the user has visited. The apparatus for searching for a place name according to an individual moving pattern includes a position detecting module for detecting a user's position, a position attribute determining module for determining an attribute of the measured position, a place name search module for searching for the place name corresponding to the measured position in accordance with the determined attribute, and a place name output module for outputting the searched place name to a user.

### CROSS-REFERENCE TO RELATED APPLICATION

This application is based on and claims priority from Korean Patent Application no. 10-2005-0090588 filed on Sep. 28, 2005, the disclosure of which is incorporated herein in by reference.

### BACKGROUND OF THE INVENTION

1. Field of the Invention

The present invention relates to an apparatus and method to search for a place name according to an individual moving pattern, and more particularly, to an apparatus and method to search for a place name according to an individual moving pattern, whereby a user can search for a place name corresponding to a place where the user visited.

2. Description of the Related Art

Recently, a portable communication device having a position determination function, such as a global position system (GPS), has been widely spread. Therefore, since a user can search for a place name of a position where the user frequently visits or place names of positions where the user has visited, using a portable communication device, the portable communication device is a great help for user to manage schedule.

Such a portable communication device can store place name information of predetermined positions during its manufacture or upgrade. The user can search for the place name of the position where the user currently visits or place names of the positions where the user has visited until now, through the place name information stored in the portable communication device.

The place name information stored in the portable communication device is stored in detail to provide detailed place name information. For example, if the user intends to search for a place name of a predetermined position, the place name can be searched for in detail, such as “167 Daechi-dong, Kangnam-ku, Seoul”.

However, if the user rarely visits the place, the detailed search for the visited place may cause confusion to the user. In other words, if the user has visited the place only once, the detailed search could cause the user confusion as to which place the user visited when the user searches for the name of the place where the user visited.

Therefore, it is necessary to provide a method varying the details of a place name in accordance with the number of times the user visited to the place, so as to enhance the user's understanding for the place name.

The Korean Patent Publication No. 10-2000-0037195 discloses an electronic map service based on Internet, in which a map of a place previously designated or clicked several times by a user is automatically displayed when the user who had accessed a web site two times or more accesses the web site that provides an electronic map service. However, this electronic map service allows the user to obtain desired information more conveniently without inputting an address or clicking a wide map, but fails to disclose a method for varying the details of a place name in accordance with the number of times the user visited to the place to enhance the user's understanding for the place name.

### SUMMARY OF THE INVENTION

Additional aspects and/or advantages of the invention will be set forth in part in the description which follows and, in part, will be apparent from the description, or may be learned by practice of the invention.

Accordingly, the present invention has been made to solve the above-mentioned problems occurring in the prior art, and an object of the present invention is to provide an apparatus and method to search for a place name according to an individual moving pattern, whereby the details of a place name are varied in accordance with the number of times a user visited to the corresponding place so as to enhance the user's understanding for the place name.

In order to accomplish these objects, there is provided an apparatus to search for a place name according to an individual moving pattern, which includes a position detecting module to detect a user's position, a position attribute determining module to determine an attribute of the measured position, a place name search module to search for the place name corresponding to the measured position in accordance with the determined attribute, and a place name output module outputting the searched place name to a user.

In another aspect of the present invention, there is provided a method searching for a place name according to an individual moving pattern, which includes detecting a user's position, determining an attribute of the measured position, searching for the place name corresponding to the measured position in accordance with the determined attribute, and outputting the searched place name to a user.

### BRIEF DESCRIPTION OF THE DRAWINGS

The above and/or other objects, features and advantages of the present invention will be more apparent from the following detailed description taken in conjunction with the accompanying drawings, in which:

FIG. 1 is a block diagram illustrating the construction of an apparatus to search for a place name according to an individual moving pattern in accordance with an embodiment of the present invention;

FIG. 2 is a flowchart illustrating a method to search for a place name according to an individual moving pattern in accordance with an embodiment of the present invention;

FIG. 3 is a view illustrating the number of visits stored in a first memory in accordance with an embodiment of the present invention;

FIG. 4 is a view illustrating position information stored in a second memory in accordance with an embodiment of the present invention;

FIG. 5 is a view illustrating the number of visits per position in accordance with an embodiment of the present invention;

FIG. 6 is a view illustrating a first attribute and a second attribute divided depending on the number of reference visits in accordance with an embodiment of the present invention;

FIG. 7 is a view illustrating a graphic interface output through a place name output module in accordance with an embodiment of the present invention; and

FIG. 8 is a view illustrating the flow of position attributes varied depending on the number of visits in accordance with an embodiment of the present invention.

### DETAILED DESCRIPTION OF THE PREFERRED EMBODIMENTS

Hereinafter, embodiments of the present invention will be described in detail with reference to the accompanying drawings. The aspects and features of the present invention and methods to achieve the aspects and features will be apparent by referring to the embodiments to be described in detail with reference to the accompanying drawings. However, the present invention is not limited to the embodiments disclosed hereinafter, but will be implemented in diverse forms. The matters defined in the description, such as the detailed construction and elements, are nothing but specific details provided to assist those of ordinary skill in the art in a comprehensive understanding of the invention, and the present invention is only defined within the scope of appended claims. In the whole description of the present invention, the same drawing reference numerals are used for the same elements across various figures.

An apparatus and method searching for a place name according to an individual moving pattern according to embodiments of the present invention will be described with reference to the accompanying drawings illustrating block diagrams and flowcharts for explaining the apparatus and method. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps to implement the functions specified in the flowchart block or blocks.

Also, each block of the flowchart illustrations may represent a module, segment, or portion of code, which includes one or more executable instructions to implement the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

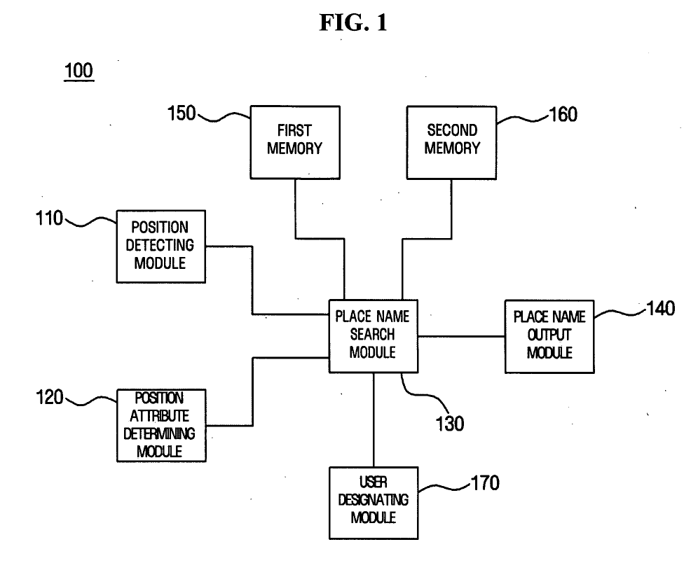

FIG. 1 is a block diagram illustrating an apparatus to search for a place name according to an individual moving pattern according to an embodiment of the present invention.

As shown in FIG. 1, an apparatus 100 to search for a place name according to an individual moving pattern in accordance with embodiment of the present invention includes a position detecting module 110 to detect a user's position, a position attribute determining module 120 to determine an attribute of the measured position, a place name search module 130 to search for a place name corresponding to the measured position according to the determined attribute, and a place name output module 140 to output the searched place name.

Furthermore, the apparatus 100 further includes a first memory 150 to store the number of visits of the user to a predetermined position, a second memory 160 to store place name information corresponding to the predetermined position, and a user designating module 170 to allow the user to designate the place name corresponding to the predetermined position. It is understood that the first memory and second memory can be combined in a single memory.

The position detecting module 110 drives a satellite receiver or base station receiver provided in a portable communication device to measure the coordinate of the position where the user currently visits in state that a power is supplied to the user's portable communication device (for example, a cellular phone and personal digital assistant (PDA)). In this case, the position detecting module 110 can measure the user's position successively or at a predetermined timing interval. In the embodiment of the present invention, the position measured by the position detecting module 110 may be expressed as absolute coordinates, for example, X and Y coordinates. The position is not limited to the X and Y coordinates. Various kinds of positions such as latitude and longitude can be measured. At this time, the position visited by the user may be a predetermined position or a region having a predetermined radius based on a predetermined position. In the embodiment of the present invention, the case where the position visited by the user is a region having a predetermined radius based on a predetermined position will be described.

Furthermore, the position detecting module 110 detects the user's position to measure the number of visits of the user to the predetermined position. The number of visits is measured if the user stays in the predetermined position for a time period more than a predetermined time. If the user stays in the predetermined position for a time period less than a predetermined time, it is understood that the user is moving. At this time, the position detecting module 110 can store information on the number of visits according to the measured position in the first memory 160. The stored information can be updated in accordance with change of the number of visits. Also, the position detecting module 110 can store the number of visits for the place name corresponding to the position where the user visited, in the first memory 150 through place name information corresponding to the user's position stored in the second memory 160.

The position attribute determining module 120 can determine the attribute of the position measured by the position detecting module 110 in accordance with the number of visits stored in the first memory 150. Specifically, the position attribute determining module 120 determines the attribute of the measured position as a first attribute if the number of visits for the predetermined position visited by the user is more than the number of reference times. The position attribute determining module 120 determines the attribute of the measured position as a second attribute if not so. Hereinafter, the position determined as the first attribute is the position frequently visited by the user while the position determined as the second attribute is the position rarely visited by the user.

Meanwhile, an embodiment of the present invention, the attribute of the measured position has been divided into the first attribute and the second attribute in accordance with the number of reference times. However, the attribute of the measured position is only an example for understanding of the present invention, and may be divided into three or more as the case may be. Also, the number of reference times may be changed in accordance with a scale and dense range of a place where the user visits.

The place name search module 130 can search for the place name of a place corresponding to the position measured by the position detecting module 110 in accordance with the attribute measured by the position attribute determining module 120. At this time, if the user stays in a predetermined position for a time period more than a predetermined time, the place name search module 130 can search for a place name of the corresponding position. The status that the user stays for a time period less than a predetermined time may be a middle path for allowing the user to move to a desired position. Therefore, if the user exceeds a predetermined stay time that can be determined as the user's visit status, the place name search module 130 can search for the place name of the corresponding position.

According to an embodiment of the present invention, the place name search module 130 can search for the place name corresponding to the position determined as the first attribute in more detail than that of the place name corresponding to the position determined as the second attribute. For example, the place name search module 130 searches for the place name corresponding to the position determined as the first attribute for “167, Daechi-dong, Kangnam-ku, Seoul” while searches for the place name corresponding to the position determined as the second attribute for “Kangnam-ku, Seoul”. In other words, an administrative district corresponding to the position determined as the first attribute is searched in more detail than an administrative district corresponding to the position determined as the second attribute. Since the position determined as the first attribute arouses the user's greater interest, the place name search module 130 searches for the place name determined as the first attribute in more detail than the place name determined as the second attribute. At this time, if the position determined as the first attribute exists in a position close to the position determined as the second attribute when the place name corresponding to the position determined as the second attribute is searched, the place name search module 130 can search for the place name corresponding to the position determined as the second attribute through the administrative district used in common in the first attribute and the second attribute. This is because that the position of the second attribute close to the position of the first attribute can sufficiently be understood by the user even if the user did not frequently visit there.

Meanwhile, the place name search module 130 can search for the place name corresponding to the measured position through information stored in the second memory 160. The user can designate the place name of the predetermined position through the user designating module 170. For example, if the place name “125, Daechi-dong, Kangnam-ku, Seoul” corresponding to the user's position is stored in the second memory 160, the user can designate the corresponding name as a place name familiar with the user or readily recognized by the user, such as “house”. In this case, if the user designates the place name of the predetermined position through the user designating module 170, the place name stored in the second memory 160 can be updated as the designated place name. Also, the place name search module 130 searches for the place name designated by the user as a first priority. Meanwhile, for place names that are not separately designated by the user, a previously designated place name or default place name may be used.

Furthermore, the place name search module 130 can generate a new position having a predetermined radius based on a position having a place name designated by the user, and the generated position can be added to the second memory 160. For example, an embodiment of the present invention, a position having a predetermined radius based on a predetermined position is described. Therefore, if the positions visited by the user are congested in a portion where two different position areas are overlapped with each other, a new position having a predetermined radius based on the portion where the positions visited by the user are congested can be generated.

The place name output module 140 can output the place name searched by the place name search module 130 through a predetermined graphic interface. An embodiment of the present invention, although the graphic interface is output in accordance with a timing flow, it may be output in accordance with a spatial position.

Hereinafter, a method for searching for a place name according to an individual moving pattern in accordance with an embodiment of the present invention will be described in detail.

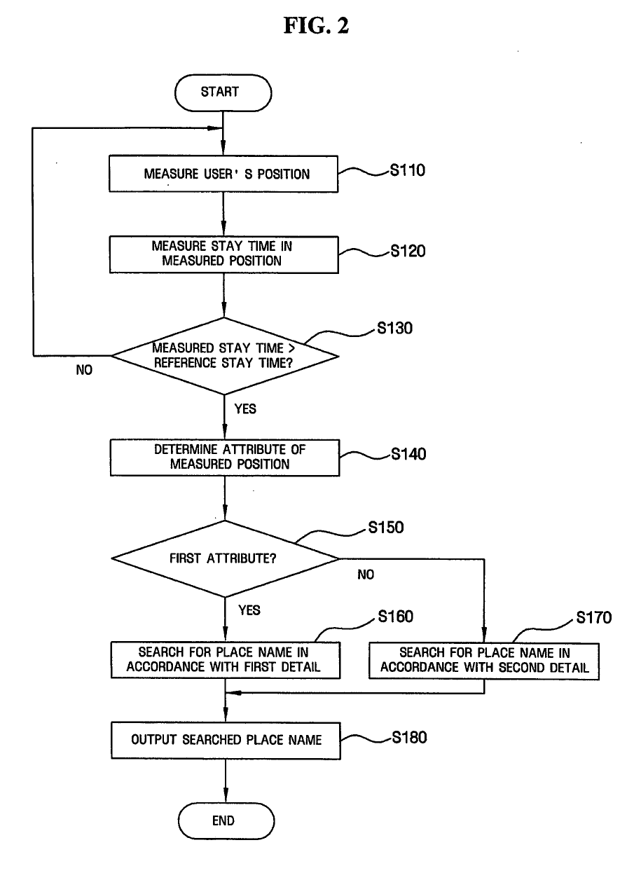

FIG. 2 is a flowchart illustrating a method to search for a place name according to an individual moving pattern in accordance with an embodiment of the present invention. In the method to search for a place name according to an individual moving pattern in accordance with an embodiment of the present invention, a user moves to a predetermined position in a state that the power of a portable communication device is applied.

As shown in FIG. 2, the position detecting module 110 detects the user's position S110. The user's position can be measured through a satellite receiver provided in the portable communication device which the user posses. Also, in the embodiment of the present invention, the user's position is measured as absolute coordinates of X and Y coordinates.

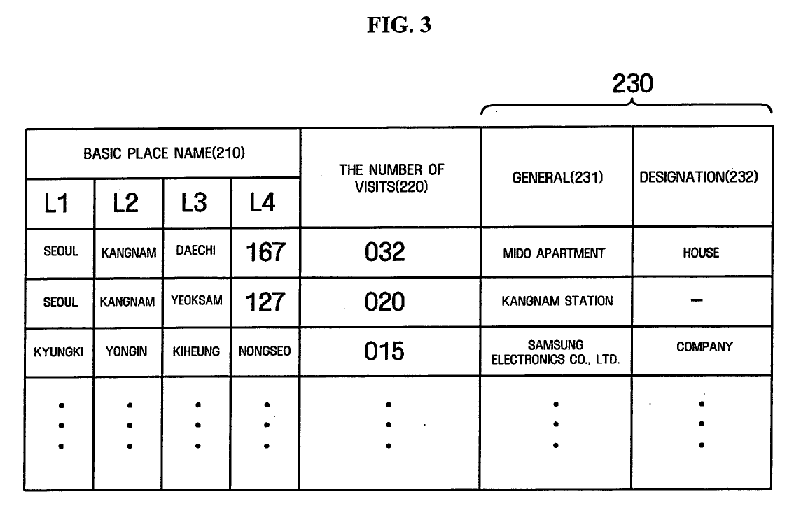

Furthermore, the position detecting module 110 measures the user's stay time at the measured position S120. It could be determined that the user visits the corresponding position if the user stays in the measured position for a time period more than a predetermined time. However, it could be understood that the user is currently moving if the user stays in the measured position for a time period less than the predetermined time. Also, the position detecting module 110 increases the number of visits to the corresponding position if it is determined that the user visits the predetermined position again. Specifically, the information on the number of visits of the user to the predetermined position can be stored in the first memory 150. The information stored in the first memory 150, as shown in FIG. 3, can include a basic place name 210 corresponding to the measured position, the number of visits 220 to the measured position, and a designated place name 230 of the measured position. At this time, the basic place name 210 is one previously stored during manufacture of the portable communication device. It is also understood that the basic place name can be updated by using Internet, telephone line or wireless. The basic place name 210 is equal to the place name information stored in the second memory 160. The position detecting module 110 extracts the place name corresponding to the measured position from the second memory 160 to store the number of visits of the user in the first memory 150.

Furthermore, the designated place name 230 is a building name or station name close to the basic place name 210 to readily recognize the position of the basic place name 210. Examples of the designated place name 230 include a generally designated place name 231 and/or a place name directly designated by the user.

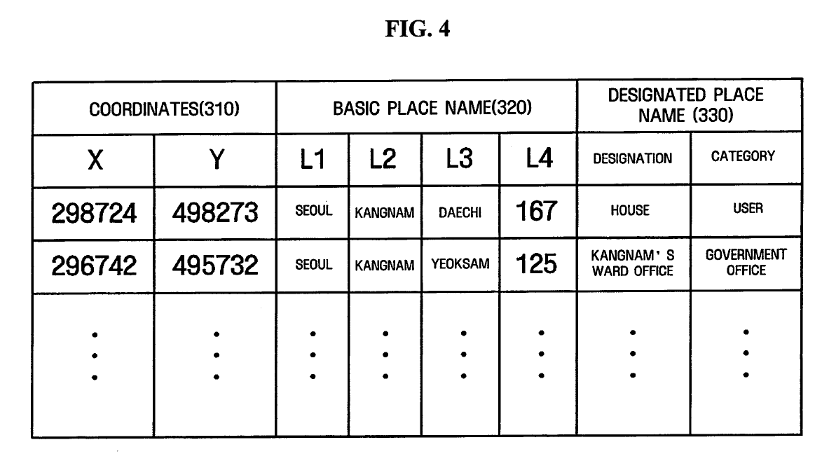

Meanwhile, as shown in FIG. 4, the place name information stored in the second memory 160 includes a coordinate 310 of the measured position, a basic place name 320 of the measured position, and a designated place name 330 of the measured position. At this time, the basic place name 320 can be divided into L1, L2, L3, and L4 in accordance with an administrative district, for example. The range of the administrative district has the relation of L1>L2>L3>L4. The designated place name 330 includes a category according to the place name designated by the user, the place name previously designated during manufacture of the portable communication device, and other corresponding place name. For example, the designated place name 330 includes the place name designated by the user, such as “house,” and the place name previously designated during manufacture of the portable communication device, such as “Kangnam's Ward Office”. The category of “house” may be “user”, and the category of “Kangnam's Ward Office” may be “government office”. It is understood that the place name can be updated later.

If the measured stay time is more than the reference stay time as a result of measuring the stay time S130, it is determined that the user visits the corresponding position. Therefore, the position attribute determining module 120 determines the attribute according to the measured position S140. According to an embodiment of the present invention, the attribute of the measured position is divided into the first attribute and the second attribute.

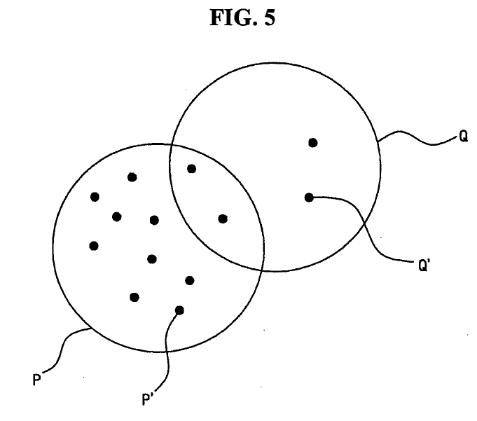

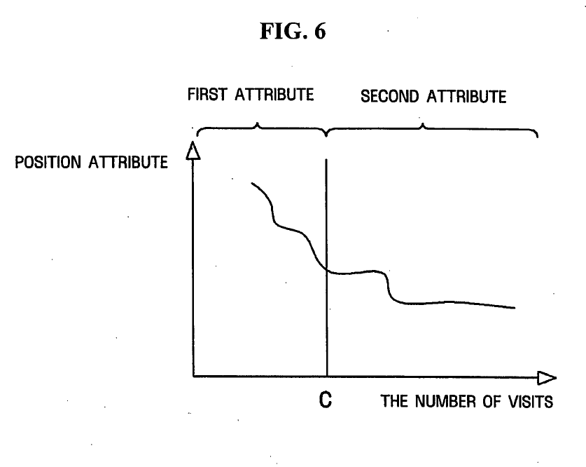

According to an aspect of the present invention, the position having the first attribute and the second attribute, as shown in FIG. 5, can be determined in accordance with the number of visits to the positions P′ and Q′ visited by the user in areas P and Q corresponding to a plurality of positions. As shown in FIG. 6, the measured position can be determined as the first attribute if the number of visits is greater than the number of reference times C, and can be determined as the second attribute if not so.

If the attribute of the measured position is determined as the first attribute, i.e., if the number of visits of the user to the corresponding position is greater than the number of reference times, the place name search module 130 searches for the place name in more detail than that of the second attribute S150. The detail for searching for the name of a place determined as the first attribute is referred to as a first detail while the detail to search for the place name determined as the second attribute is referred to as a second detail.

According ton an embodiment of the present invention, the detail for searching for the place name is divided into L1, L2, L3 and L4, wherein L1 represents special municipality/megalopolis/province, L2 ward/city, L3 village/town, and L4 ri/address for example. Also, the place name searched in accordance with the first detail includes L1, L2, L3 and L4, and the place name searched in accordance with the second detail includes L1 and L2. But it is not limited thereto.

If the attribute of the measured position is determined as the second attribute, the place name search module 130 searches for the place name in the second detail that is lower than the first detail S160.

If the place name of the position having the first attribute or the second attribute is completely searched, the place name search module 130 outputs the place name searched through a predetermined graphic interface S170.

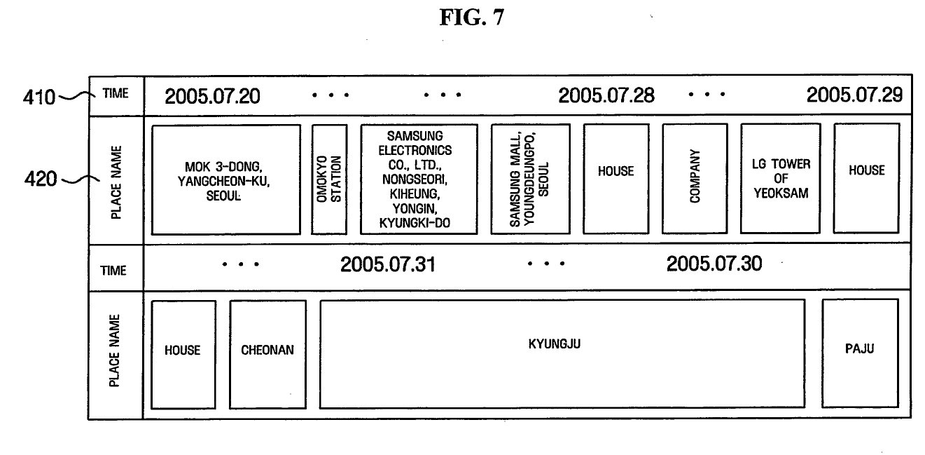

At this time, the output graphic interface, as shown in FIG. 7, may include a place name field 420 of a position visited by the user with respect to a time field 410. Also, it is noted that place names included in the place name field 420 are respectively output at different details in accordance with their corresponding attributes. Meanwhile, a predetermined desired place name designated by the user may be output to the graphic user interface of FIG. 7. For example, it is noted that the place name output as “Mok 3-dong, Yangcheon-ku, Seoul” on Jul. 20, 2005 was output as “house” on Jul. 28, 2005. In this case, “Mok 3-dong, Yangcheon-ku, Seoul” is designated by the user as “house” through the user designating module 170. As another example, it is noted that the place name “Samsung Electronics Co., Ltd., Nongseori, Kiheung, Yongin, Kyungki-do” was output as “company” designated by the user.

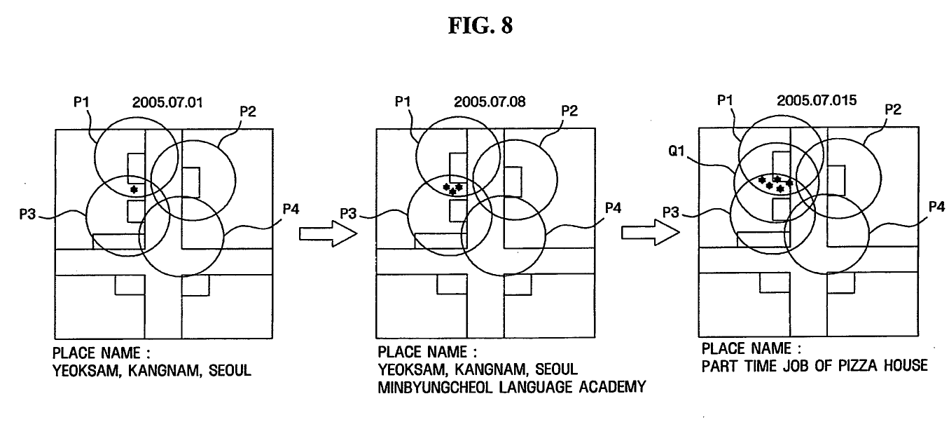

FIG. 8 is a view illustrating the flow of the searched place names varied depending on the number of visits of the user in accordance with an embodiment of the present invention. Referring to FIG. 8, the positions visited by the user on Jul. 1, 2005, Jul. 8, 2005, and Jul. 15, 2005 are displayed as asterisks.

As shown in FIG. 8, it is noted that the number of visits of the user increases with the passage of time and thus the attribute of the searched place name is varied from the second attribute to the first attribute. Specifically, it is noted that the place name is searched as “Yeoksam, Kangnam, Seoul” as of Jul. 1, 2005 but varied to “Minbyungcheol Language Academy, Yeoksam, Kangnam, Seoul”. In this case, it is noted that the position determined as the second attribute as of Jul. 1, 2005 is determined as the first attribute as of Jul. 8, 2005. Also, it is noted that “part-time job of pizza house” designated by the user is used as of Jul. 15, 2005.

At this time, the user can generate a new position coordinate based on the position visited by the user. In other words, in addition to areas P1, P2, P3 and P4 corresponding to the existing positions, the user can newly generate an area Q1 corresponding to the position frequently visited by the user to store the area Q1 in the second memory 160. At this time, the newly generated area Q1 is formed to over the existing areas P1, P2, P3 and P4. In this case, the place name corresponding to Q1 not the place names corresponding to P1 to P4 can be searched if the user visits the position corresponding to Q1 in the areas P1 to P4. Therefore, it is possible to enhance the user's understanding for the place name. As a result, the user can search for the place name familiar with the user and desired by the user without any limited search for the place name.

In the apparatus and method to search for the place name according to the individual moving pattern according to embodiments of the present invention, the term “unit” means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

As described above, in the apparatus and method to search for a place name according to an individual moving pattern, the detail level of the place name is varied in accordance with the number of visits of the user to the predetermined position so as to enhance the user's understanding for the place name corresponding to the predetermined position.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus to search for a place name according to an individual moving pattern comprising:
a position detecting module to detect a user's position;
a position attribute determining module to determine an attribute of the detected position;
a place name search module to search for the place name corresponding to the measured position in accordance with the determined attribute; and
a place name output module to output the searched place name to a user.

2. The apparatus as claimed in claim 1, wherein the position determining module determines the attribute as a first attribute if the user has visited a predetermined position the number of reference times or greater, and determines the attribute as a second attribute if not.

3. The apparatus as claimed in claim 2, further comprising:
a first memory to store information on the number of visits of the user to the predetermined position; and
a second memory to store information on the place name corresponding to the predetermined position.

4. The apparatus as claimed in claim 1, further comprising:
a user designating module to allow the user to designate the place name corresponding to the predetermined position.

5. The apparatus as claimed in claim 2, wherein the place name search module determines details of searching for the place name corresponding to the detected position in accordance with the determined attribute.

6. The apparatus as claimed in claim 2, wherein the place name search module searches an administrative district as the place name if the positions determined as the first and second attributes are included in the same administrative district and the place name of the position determined as the second attribute is searched for.

7. The apparatus as claimed in claim 3, wherein the place name search module updates the place name stored in the second memory as the designated place name if the user designates a place name corresponding to a predetermined position.

8. The apparatus as claimed in claim 7, wherein the place name search module sets the place name designated by the user as a first priority when searching for the place name corresponding to the measured position.

9. A method to search for a place name according to an individual moving pattern comprising:
detecting a user's position;
determining an attribute of the detected position;
searching for a place name corresponding to the detected position in accordance with the determined attribute; and
outputting the searched place name to the user.

10. The method as claimed in claim 9, wherein the determining an attribute of the detected position comprises:
determining the attribute as a first attribute if the user has visited a predetermined position the number of reference times or greater, and determining the attribute as a second attribute if not.

11. The method as claimed in claim 10, further comprising:
storing the place name corresponding to the predetermined position;
storing the number of visits of the user to the predetermined position; and
allowing the user to designate the place name corresponding to the predetermined position.

12. The method as claimed in claim 10, wherein the determining the place name comprises:
determining details for searching for the place name corresponding to the measured position in accordance with the determined attribute.

13. The method as claimed in claim 10, wherein the searching for the place name comprises:
searching an administrative district as the place name if the positions determined as the first and second attributes are included in the same administrative district and the place name of the position determined as the second attribute is searched for.

14. The method as claimed in claim 11, further comprising:
updating the stored place name as a designated place name if the user designates the place name corresponding to a predetermined position.

15. The method as claimed in claim 14, wherein searching for the place name comprises:
searching for the place name designated by the user as a first priority when the place name corresponding to the measured position is searched.

16. The method as claimed in claim 9, wherein the searched place name is outputted different forms according to the determined attribute of the detected position.
